(19) United States
(12) Patent Application Publication
(10) Pub. No.: US 2013/0128567 A1
(43) Pub. Date: May 23, 2013

(54) Light Emitting Diode (LED) Lamp Tube Structure

(71) Applicants: Cheng-Ming Lee, Jhubei City (TW); Chun-Chen Liu, Jhubei City (TW); Yu-Kuan Chang, Jhubei City (TW)

(72) Inventors: Cheng-Ming Lee, Jhubei City (TW); Chun-Chen Liu, Jhubei City (TW); Yu-Kuan Chang, Jhubei City (TW)

(21) Appl. No.: 13/591,535

(22) Filed: Aug. 22, 2012

(30) Foreign Application Priority Data
Nov. 22, 2011 (TW) 100222070

(51) Int. Cl. F21V 1/00

(52) U.S. Cl. 362/217.02

(57) ABSTRACT

An improved light emitting diode (LED) lamp tube structure, comprising a lampshade, at least an LED lamp strap installed inside the lampshade and at least a drive circuit installed on any side of the interior of the lampshade, wherein the drive circuit includes multiple electronic components and a drive circuit board, in which the electronic components are insertion installed on one side of the drive circuit board, and at least an LED is insertion installed on the other side of the drive circuit board. Therefore, when the drive circuit drives the LED lamp strap to illuminate, it also drives the LEDs insertion installed on the other side of the drive circuit board to light up at the same time so the entire lampshade can illuminate completely.

The current application claims a foreign priority to the patent application of Taiwan No. 100222070 filed on Nov. 22, 2011.

### BACKGROUND OF THE INVENTION

1. Field of the Invention

The present invention generally relates to an improved light emitting diode (LED) lamp tube structure; in particular, the present invention relates to an improved LED lamp tube structure enables increased illumination range of the entire lampshade.

2. Description of Related Art

Featuring many advantages such as better power saving, longer life span, smaller size and faster reaction speed or the like, light emitting diodes (LEDs) are at present comprehensively applied in various illumination fields. Now certain manufacturers have developed the LED lamp tube allowable for replacement of fluorescent lamps. A common LED lamp tube has a long-strapped lampshade for accommodations of the LED lamp strap and the drive circuit, and two left and right LED lamp straps including multiple LEDs are respectively installed in the long-strapped lampshade. Also, a drive circuit is installed on both the two sides of the interior of the long-strapped lampshade thereby driving the LEDs on the LED lamp strap to illuminate.

Since both sides of the interior of the long-strapped lampshade are respectively installed with the drive circuit, the illumination range of the long-strapped lampshade is thus restricted to the area installed with the LED lamp strap between such two drive circuits, indicating that the long-strapped lampshade can only provide a very limited illumination range. In case the user is located on either side of the long-strapped lampshade, the luminance projected onto the user will inevitably decrease; hence, such an issue needs to be resolved in the industry.

Accordingly, some manufacturers have made certain improvements on the design for the interior of the long-strapped lampshade 11 of the LED lamp tube 1, in which the drive circuits 13 are moved from the two sides of the interior of the long-strapped lampshade 11 to the top of the LED lamp strap 12, as shown in FIGS. 1A, 1B and 2. In this way, the LED lamp strap 12 can extend to both the left and right sides of the interior of the long-strapped lampshade 11, so the illumination range of the LED lamps 121 in the LED lamp strap 12 may be enlarged in order to resolve the aforementioned problem.

However, with such a solution, it may need to lower down the position of the LED lamp strap 12 because the drive circuit 13 is positioned on top of the LED lamp strap 12, consequently the LED lamp strap 12 may have a narrower accommodation space or even become very close to the surface of the long-strapped lampshade 11. Therefore, the LED lamps 121 installed in the LED lamp strap 12 must be of small sizes in order that the LED lamp strap 12 can be successfully placed into this limited accommodation space. Moreover, since the LED lamp strap 12 may be very close to the surface of the long-strapped lampshade 11, the LED lamps insertion installed on the LED lamp strap 12 need to be sufficiently dense, otherwise the user may easily observe such apparently dispersed LED lamps 121 during illumination. At the same time, the LED lamps 121 of small sizes may cause the similar problem, since each of the LED lamps 121 of small sizes provides less luminance and adjacent LED lamps 121 may lead to uneven distribution of luminance emitted from the long-strapped lampshade 11, so such LED lamps 121 also have to be installed in a very dense configuration; however, higher density implies more LED lamps 121, thus undesirably elevating manufacture costs thereof.

Consequently, with regards to solutions to the above-said issues, enabling the complete illumination of the entire lampshade without squeezing the accommodation space for the LED lamp strap would be an optimal solution.

### SUMMARY OF THE INVENTION

The present invention provides an improved light emitting diode (LED) lamp tube structure enabling an increased illumination range of the entire lampshade.

An improved LED lamp tube structure offering the aforementioned feature comprises a lampshade, at least an LED lamp strap installed inside the lampshade and at least a drive circuit installed on any side of the interior of the lampshade, wherein the drive circuit includes multiple electronic components and a drive circuit board, in which the electronic components are insertion installed on one side of the drive circuit board, and at least an LED is insertion installed on the other side of the drive circuit board; accordingly, when the drive circuit drives the LED lamp strap to illuminate, it also drives the LEDs insertion installed on the other side of the drive circuit board to light up at the same time so the entire lampshade may illuminate completely; meanwhile, the LEDs insertion installed on the drive circuit board located on any side of the interior of the lampshade can enlarge the illumination range of the entire lampshade.

More specifically, the aforementioned LED lamp strap includes a plurality of LEDs, and the LEDs insertion installed on the other side of the drive circuit board face in the same direction as the LEDs in the LED lamp strap face.

More specifically, the aforementioned lampshade is of a long-strapped shape.

More specifically, the aforementioned drive circuit is connected to the LED lamp strap and used to drive the LEDs insertion installed on the other side of the drive circuit board as well as the LED lamp strap to illuminate.

More specifically, the aforementioned electronic components can be electronic components such as resistors, capacitors or transformers and the like.

### BRIEF DESCRIPTION OF THE DRAWINGS

FIG. 1A shows an assembled structural diagram of a prior art LED lamp tube;

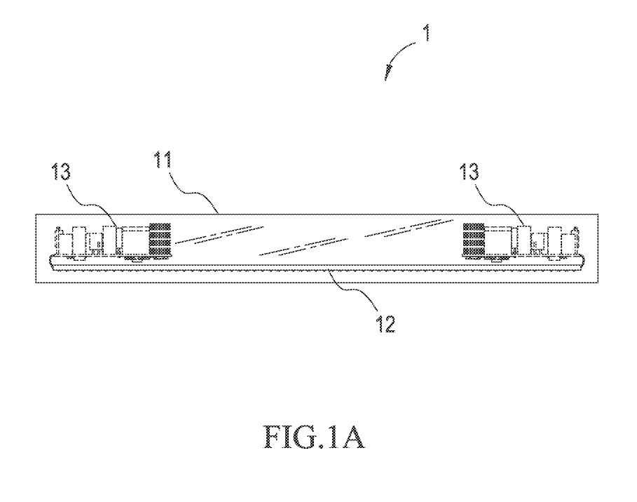

FIG. 1B shows a disassembled structural diagram of a prior art LED lamp tube;

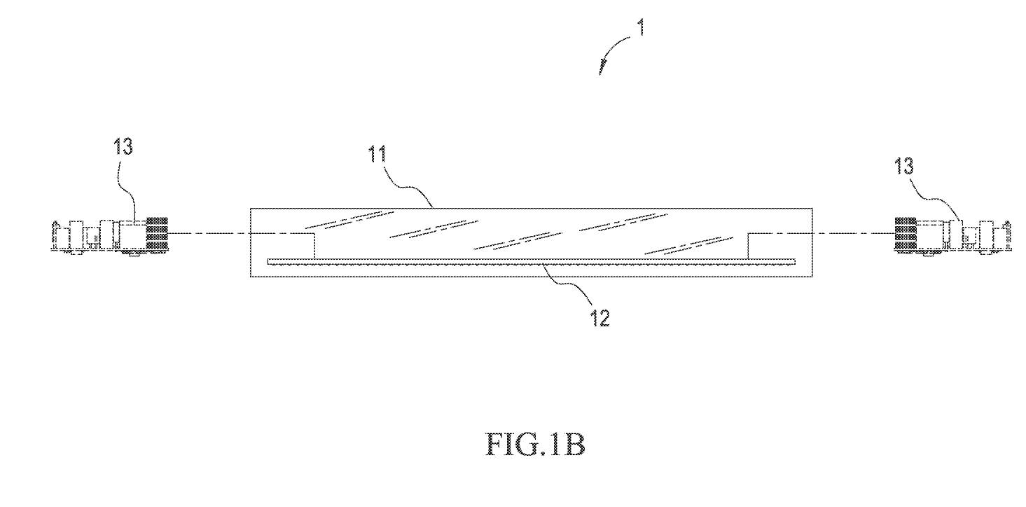

FIG. 2 shows a side view for illumination of a prior art LED lamp tube;

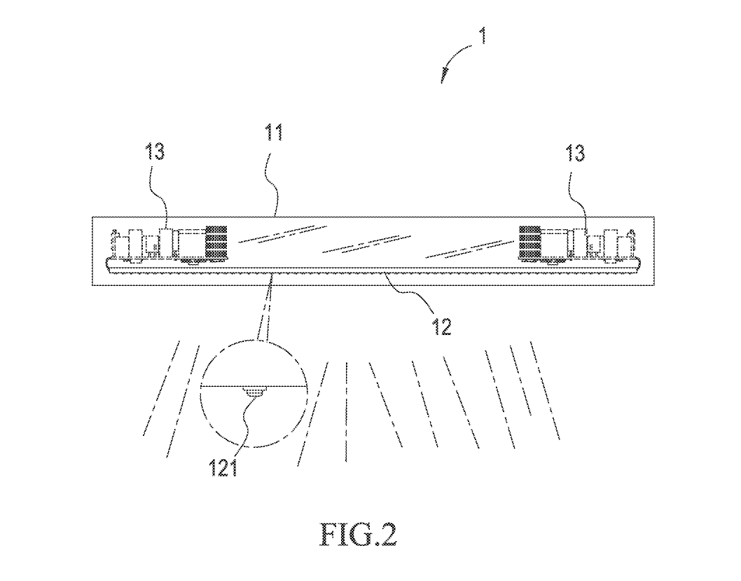

FIG. 3A shows an assembled structural diagram for a first embodiment of the improved LED lamp tube structure according to the present invention;

FIG. 3B shows a disassembled structural diagram for the first embodiment of the improved LED lamp tube structure according to the present invention;

FIG. 4 shows a structural diagram of the drive circuit in the improved LED lamp tube structure according to the present invention;

FIG. 5 shows a top view for the first embodiment of the improved LED lamp tube structure according to the present invention;

FIG. 6 shows a side view for illumination of the first embodiment of the improved LED lamp tube structure according to the present invention; and

FIG. 7 shows a side view for illumination of a second embodiment of the improved LED lamp tube structure according to the present invention.

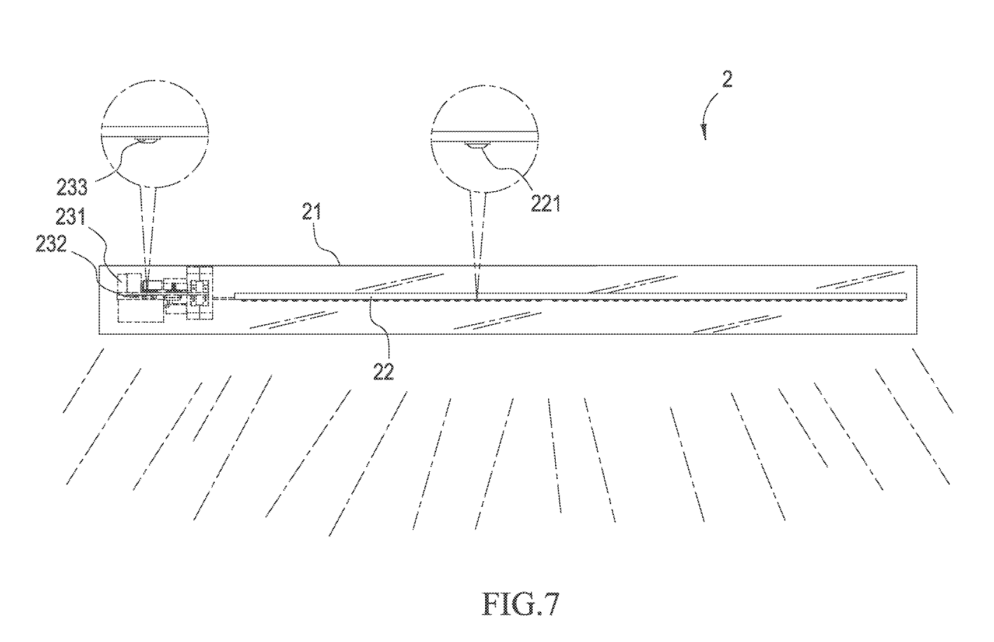

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

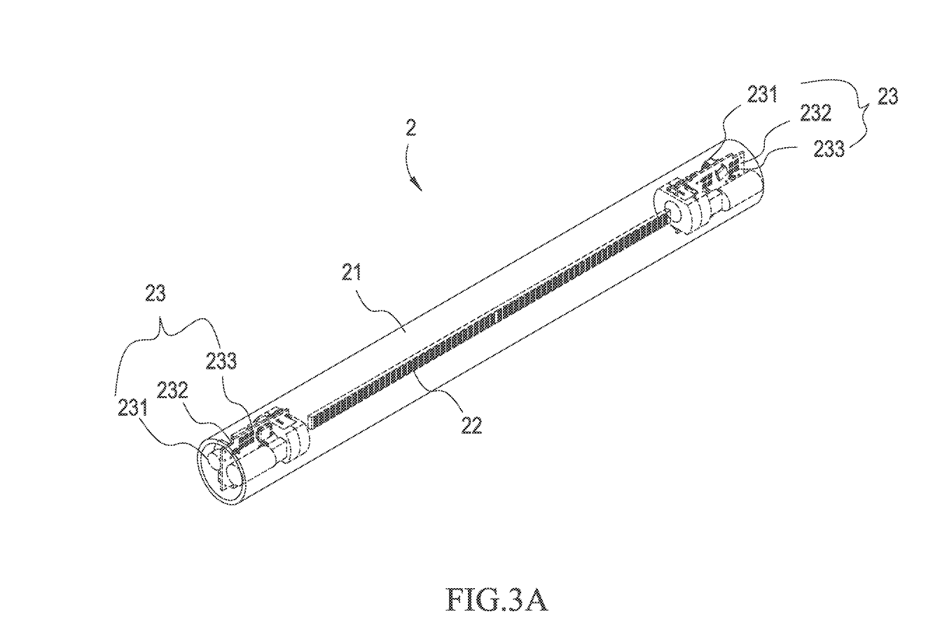

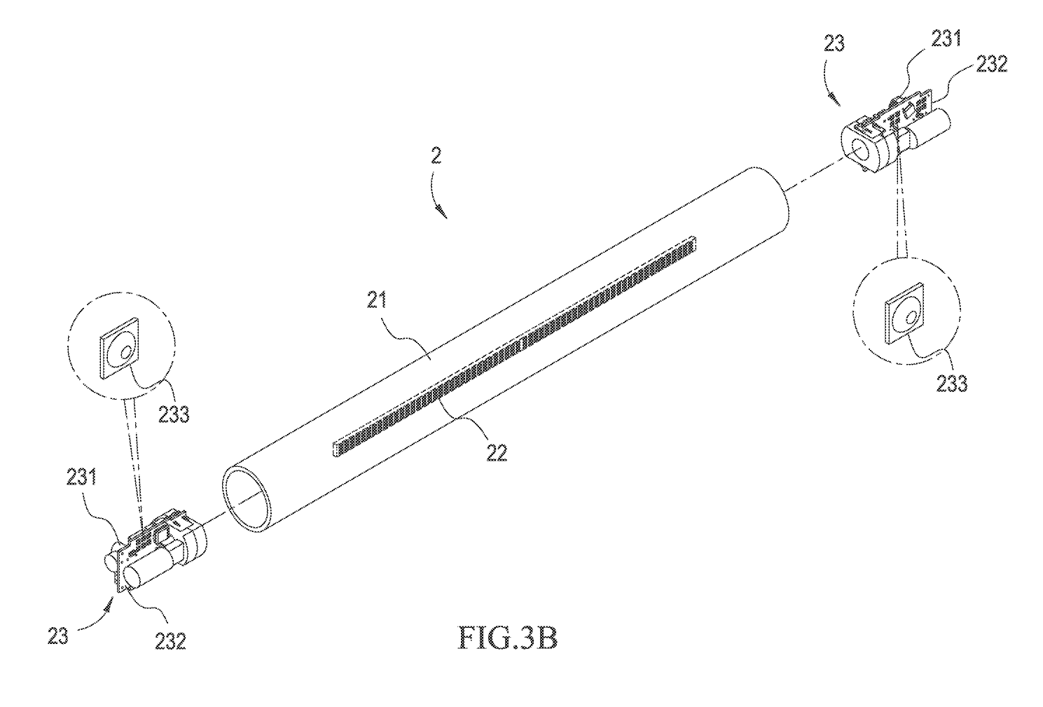

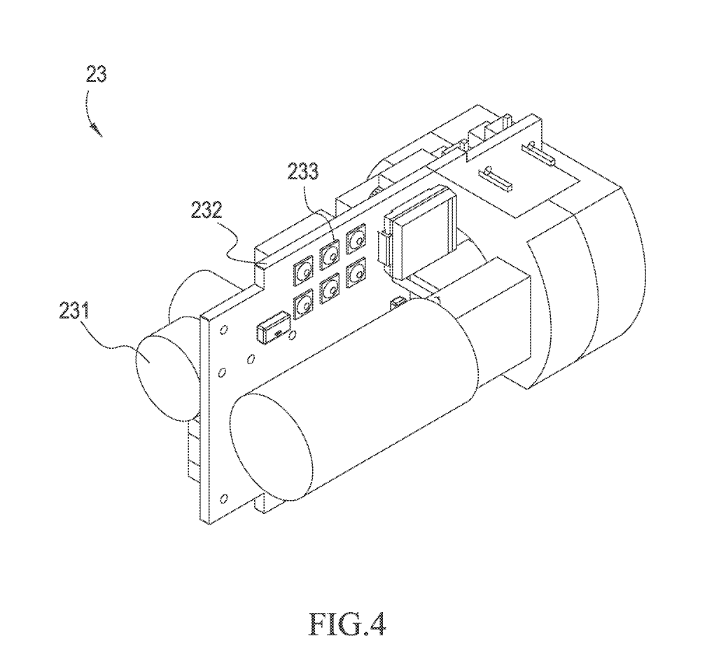

Refer now to FIGS. 3A and 3B, wherein an assembled structural diagram and a disassembled structural diagram for a first embodiment of the improved LED lamp tube structure according to the present invention is respectively shown. It can be seen from the Figures that the improved LED lamp tube structure 2 comprises a lampshade 21, at least an LED lamp strap 22 and at least a drive circuit 23, wherein the LED lamp strap 22 and the drive circuit 23 are installed inside the lampshade 21, the drive circuit 23 includes multiple electronic components 231 (e.g., electronic components such as resistors, capacitors or transformers and the like) and a drive circuit board 232, and the electronic components 231 are insertion installed on one side of the drive circuit board 232. Also, as shown in FIG. 4, at least an LED 233 is insertion installed on the other side of the drive circuit board 232.

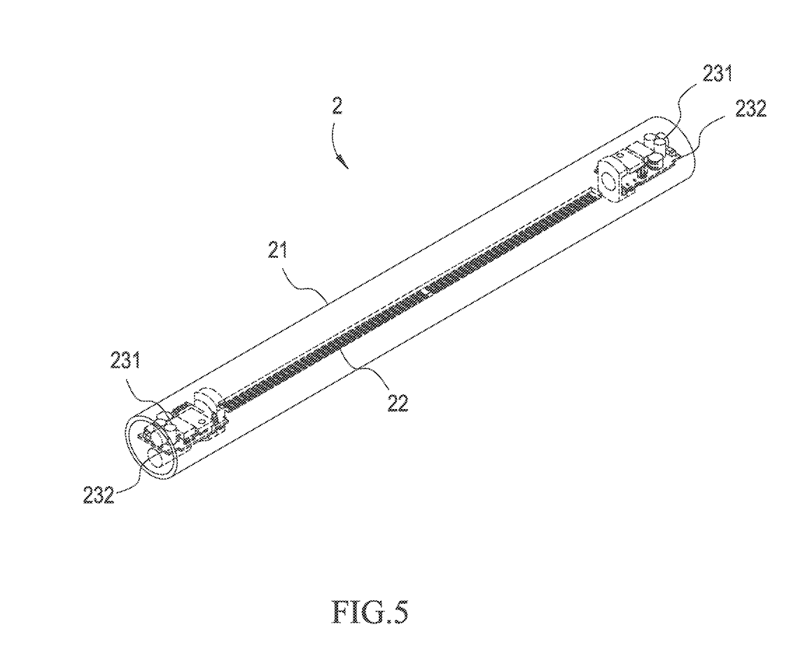

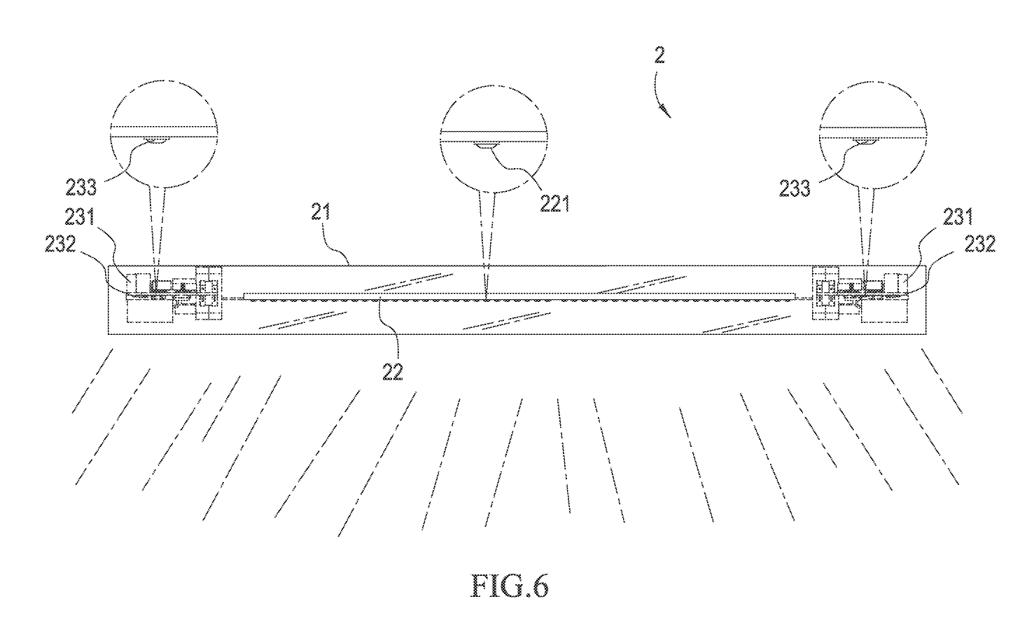

Moreover, in FIG. 5, a top view for the first embodiment of the improved LED lamp tube structure according to the present invention is shown. By comparing FIGS. 3A and 5, it can be appreciated that the LEDs 233 insertion installed on the other side of the drive circuit board 232 face in the same direction as the LEDs 221 in the LED lamp strap 22 face, so, in case the drive circuit 23 is placed on any side of the interior of the lampshade 21 and connected to the LED lamp strap 22, the drive circuit 23 can drive the LEDs 233 insertion installed on the other side of the drive circuit board 232 and the LEDs 221 in the LED lamp strap 22 to illuminate. Therefore, as shown in FIG. 6, when the drive circuit 23 drives the LED lamp strap 22 to illuminate, it also drives the LEDs 233 insertion installed on the other side of the drive circuit board 232 to light up at the same time so the entire lampshade 21 may illuminate completely.

Accordingly, it can be seen that such an embodiment enables the complete illumination of the entire lampshade 21, and further the increased illumination range of the entire lampshade 21 as well. Besides, in addition to the aforementioned configuration for the placement of the drive circuit 23 including LEDs 233 respectively on both the left and right sides of the interior of the lampshade 21, it also allows a configuration for the placement of the drive circuit 23 including LEDs 233 on either side of the interior of the lampshade 21, thereby offering a greater space in the lampshade 21 for the LED lamp strap 22 such that the illumination range of the entire lampshade 21 can be further enlarged.

Compared with prior art, the improved LED lamp tube structure provided by the present invention further offers the following advantages:

1. The present invention is able to enlarge the illumination range of the entire lampshade, so that, even the user is located on any side of the lampshade, the luminance projected onto the user will not decrease.

2. The present invention allows the installation of LEDs from one side of the lampshade to the other side, and the accommodation space of the LED lamp strap will not be squeezed. Therefore, the LEDs on the LED lamp strap may be LEDs of greater power, and such LEDs of higher luminance may not be easily differentiated by the user even the neighboring space between LEDs on the LED lamp strap becomes wider. As a result, the present invention can effectively use less LEDs in order to reduce manufacture costs.

By way of the aforementioned detailed descriptions for the preferred embodiments according to the present invention, it is intended to better illustrate the characters and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. An improved light emitting diode (LED) lamp tube structure, comprising a lampshade, at least an LED lamp strap installed inside the lampshade and at least a drive circuit installed on any side of the interior of the lampshade, characterized in that: the drive circuit includes multiple electronic components and a drive circuit board, in which the electronic components are insertion installed on one side of the drive circuit board, and at least an LED is insertion installed on the other side of the drive circuit board.

2. The improved LED lamp tube structure according to claim 1, wherein the LED lamp strap includes a plurality of LEDs.

3. The improved LED lamp tube structure according to claim 1, wherein the LEDs insertion installed on the other side of the drive circuit board face in the same direction as the LEDs in the LED lamp strap face.

4. The improved LED lamp tube structure according to claim 1, wherein the lampshade is of a long-strapped shape.

5. The improved LED lamp tube structure according to claim 1, wherein the drive circuit is connected to the LED lamp strap and used to drive the LEDs insertion installed on the other side of the drive circuit board as well as the LED lamp strap to illuminate.

6. The improved LED lamp tube structure according to claim 1, wherein the electronic components can be electronic components such as resistors, capacitors or transformers and the like.
